(19) United States
(12) Patent Application Publication
(10) Pub. No.: US 2007/0047655 A1
(43) Pub. Date: Mar. 1, 2007

(54) Transpose buffering for video processing

(76) Inventors: Eric F. Vannerson, Phoenix, AZ (US); Louis Lippincott, Los Altos, CA (US)

Correspondence Address: TROP PRUNER & HU, PC, 1616 S. VOSS ROAD, SUITE 750, HOUSTON, TX, 77057-2631, US

(21) Appl. No.: 11/213,160

(22) Filed: Aug. 26, 2005

(51) Int. Cl. H04N 11/04; H04N 7/12

(52) U.S. Cl. 375/240.24; 375/240.26

(57) ABSTRACT

A transpose buffer may store 8×8 and smaller sized blocks of video data. When the smaller sized blocks arrive, they can be reconfigured to fit within the available space within the buffer.

### BACKGROUND

This invention relates generally to processing video.

Because of the need to transmit large amounts of data containing detailed information, it is desired to conserve the available bandwidth of transport media. To this end, video information may be compressed using a variety of well known compression techniques. Received video in compressed format may be decompressed. As a result, the video may be transmitted more compactly, enabling lower bandwidth transport media to be utilized while conserving the bandwidth of higher bandwidth transport media.

Several compression standards require a two-dimensional transformation of the data. This transformation is generally performed in one dimension at a time, with intermediate results stored in a transpose buffer or transpose random access memory (RAM). 8×8 blocks of video information called pels may be processed as atomic units, or may be divided into 4×8, 8×4, or 4×4 sub-blocks for processing.

Thus, blocks of video data may be stored in transpose buffers in the course of coding and decoding. In some compression standards (e.g., Moving Pictures Experts Group (ISO/IEC 13818) (MPEG-2)) only 8×8 blocks are processed. In others (e.g., Microsoft Windows Media® 9) some 8×8 blocks may be replaced by two 4×8 sub-blocks, two 8×4 sub-blocks, or four 4×4 sub-blocks.

### BRIEF DESCRIPTION OF THE DRAWINGS

FIG. 1 is a schematic depiction of one embodiment of the present invention;

FIG. 2 is a more detailed depiction of a portion of the embodiment shown in FIG. 1 in accordance with one embodiment of the present invention;

FIG. 3 is a depiction of the logical arrangement of a transpose buffer in accordance with one embodiment of the present invention;

FIG. 4 is a write sequence in accordance with one embodiment of the present invention; and

FIG. 5 is a read sequence in accordance with one embodiment of the present invention.

### DETAILED DESCRIPTION

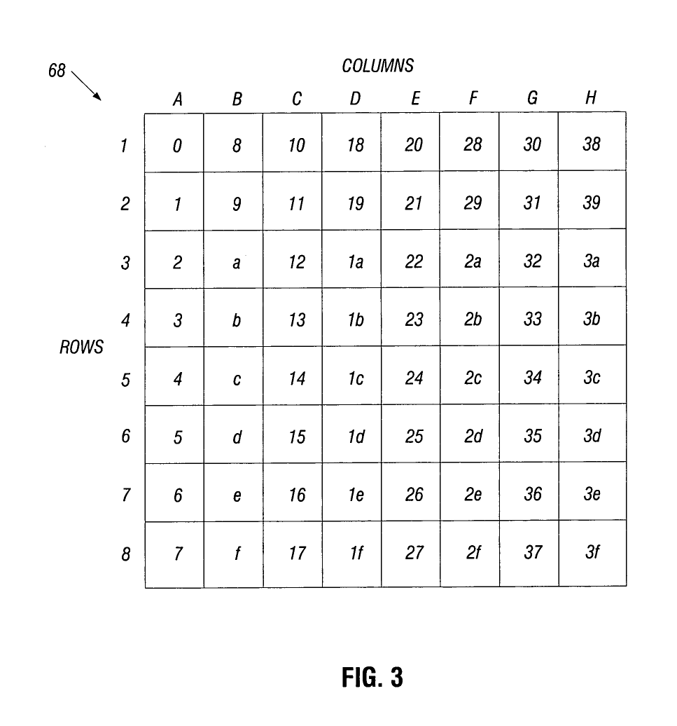

In some embodiments of the present invention, a transpose buffer may be used in connection with video compression and decompression. The transpose buffer may be written to and read from in connection with one-dimensional compression transforms performed in sequence. The transpose buffer may be managed to most effectively and efficiently buffer the compression information in some embodiments. Although in general the transpose buffer is an ordinary 64-word RAM with linear addressing, it is convenient to think of the RAM locations as occupying positions in a two-dimensional array as shown in FIG. 3 (The assignment of addresses to these array positions is arbitrary). With this visualization, one can refer to writing column-wise and reading row-wise, or writing row-wise and reading column-wise (This transpose is the primary purpose of the RAM).

Consider the case in which a series of 8×8 blocks is to be processed. The first block may be written column-wise and read row-wise. The second block may be written column-wise as well, but then the first column cannot be written until 57 words of the first block have been read (the first 7 rows and the first word of the last row). This imposes a serious limitation on processing throughput. Recognizing however that it makes no difference whether we write column-wise or row-wise so long as we read row-wise or column-wise respectively, the second block may be written row-wise and read column-wise. Then, the first row of the second block may be written after only eight words of the first block have been read. This may result in a very substantial throughput improvement in some embodiments.

A complication arises when a block is divided into a set of sub-blocks. There is no unique optimal order for writing and reading in this case, but following some general principles may maximize throughput and simplify addressing in some cases:

1) Write and read order may be toggled from column-wise to row-wise or vice versa after a complete block (not a sub-block) has been written or read.

2) When writing column-wise, each sub-block may completely fill n rows, where n=2 for 4×4 sub-blocks and 4 for 4×8 or 8×4 sub-blocks. Similarly, when writing row-wise, each sub-block may completely fill n columns, where n=2 or 4.

3) When writing column-wise, addressing may be such that the first vector(s) (one or two) that will be read occupy the first buffer row of the sub-block. For example, a 4×4 sub-block can be written to the following addresses:

| Row | Addresses |
|---|---|
| 0 | 0, 20, 1, 21 |
| 1 | 8, 28, 9, 29 |
| 2 | 10, 30, 11, 31 |
| 3 | 18, 38, 19, 39 |

Note that the first two vectors to be read occupy addresses 0, 8, 10, 18 and 20, 28, 30, 38, which is the first row of the buffer. This row is thus cleared as quickly as possible for the next block. Similarly, when writing, row-wise addressing may be such that the first vector(s) (one or two) that are read occupy the first buffer column of the sub-block.

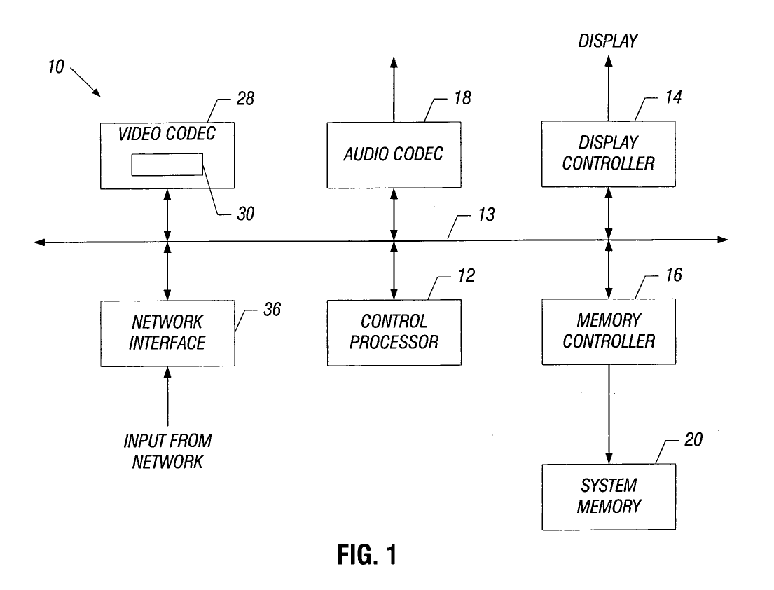

Referring to FIG. 1, a processor-based system 10 may, for example, be a set top box, a digital versatile disk (DVD) player, a compact disk (CD) player, a personal digital assistant, a portable music player, or a car stereo, to mention a few examples. In some embodiments of the present invention, the system 10 may use the Microsoft® Windows Media® 9 inverse transform. This compression technology handles both audio and video information.

The Windows Media® 9 transform is a two-dimensional transform similar in principle to a discrete cosine transform (DCT). Like the DCT, the Windows Media® 9 inverse transform is separable, meaning that the Windows Media® 9 inverse transform can be decomposed into two one-dimensional (1D) transforms performed in sequence.

Referring to FIG. 1, a processor 12 is coupled over the bus 13 and establishes communications between the processor 12, a memory controller 16, a network interface 36, a display controller 14, an audio coder/decoder 18, and a video coder/decoder (codec) 28. The audio coder 18 supplies output audio. The display controller 14 may be coupled to a display (not shown). The memory controller 16 couples a system memory 20. The system memory may be a dynamic random access memory or a flash memory, as two examples. The network interface 36 allows communications with other systems (not shown).

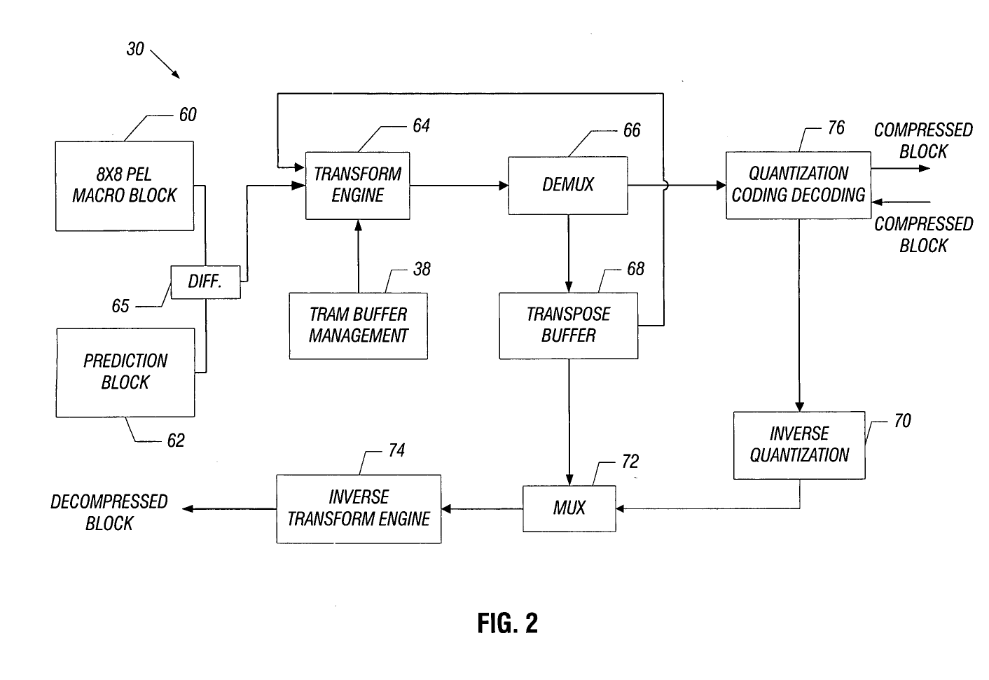

The video codec 28 may handle video processing in general, including compression and decompression. The decoder/coder 28 may include a Moving Pictures Experts Group (MPEG) and Windows Media® 9 (WM9) coder and decoder 30 (see FIG. 2).

In some embodiments, the system 10 may be a set top box. The present invention is no way limited to the particular architecture described above and shown in FIG. 1, which are provided for purposes of example only.

Referring to FIG. 2, the video compression/decompression unit 30 may include a motion compensation unit coupled to a coding engine. The coding engine, in one embodiment, may be a Windows Media® 9 transform engine which compresses incoming video. Thereafter, quantization and variable length coding may be implemented as indicated. The output from the coding engine may be provided to the transform buffer 68. The transform buffer 68 is read by the transform engine 64.

More particularly, the current 8×8 pel microblock 60 and a prediction 62 are received and their difference determined at 65 for motion compensation. The transform engine 64 then works in two passes. In the first pass, the transform engine 64 operates column-wise and writes the results of the first one-dimensional operation into the transpose buffer 68 via the demultiplexer 66. Then, the transform engine 64 fetches the columns from the transpose buffer 68 to do the second pass. Control logic or software 38 within the transpose buffer 68 may enable matrix transpose operations between the first and second passes. Then, the results from the second pass are passed on to the quantization and coding and decoding stages 76. A compressed block may result. Also, a compressed block may be received and decompressed by inverse quantization 70, demultiplexing 72, and the inverse transform engine 74.

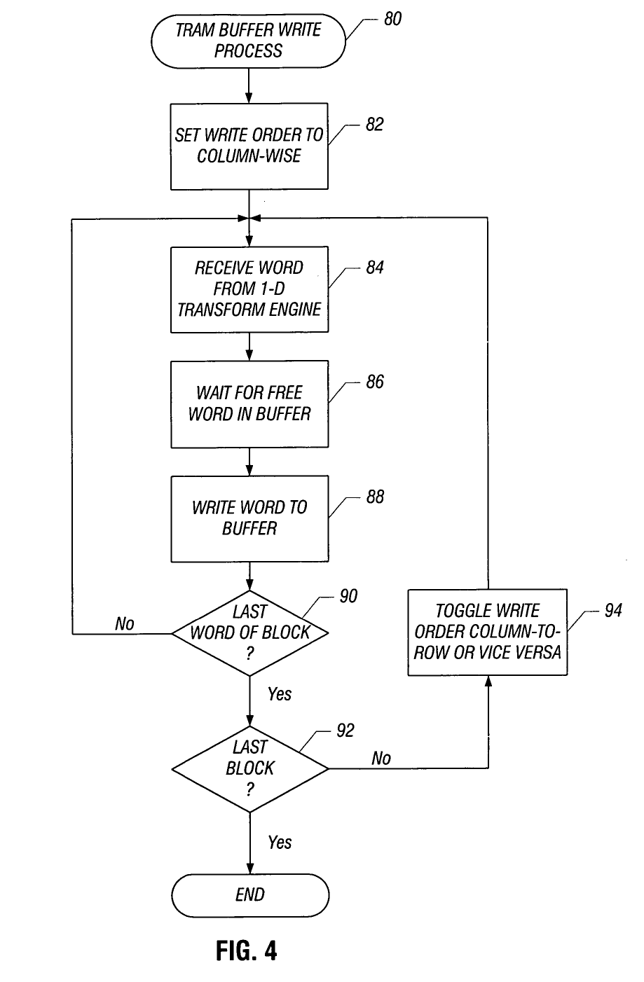

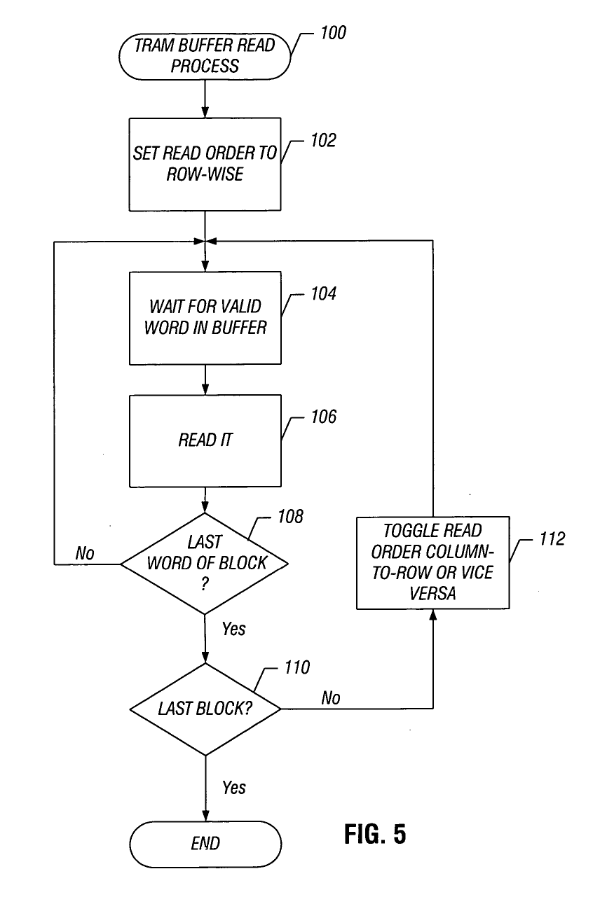

Referring to FIGS. 4 and 5, the transform buffer 68 management may be implemented in software, firmware, or hardware, which may be stored in association with the transform engine 64 in one embodiment.

While an embodiment using a Windows Media® 9 transform is described, other transforms may also be used, including discrete cosine transforms and the like, such as Moving Picture Experts Group (ISO/IEC 13818) and VC-1 Society of Motion Picture Television Engineers(SMPTE) transforms.

Referring to FIG. 4, the write process for the transpose buffer is indicated at 80 in accordance with one embodiment. Initially, the write order may be set to column-wise as indicated in block 82. A word may be received from a 1D transform engine as indicated in block 84. The sequence waits for a free word in the transpose buffer as indicated at 86. When the free word is available, a word is written to the buffer as indicated in block 88.

A check at diamond 90 determines whether the last word of the block has been written. If so, a check at diamond 92 determines whether that block is the last block to be written. If not, the write order is toggled from column to row or vice versa as indicated in block 94. If so, the process ends.

Referring to FIG. 5, the read process for the transpose buffer is indicated at 100 in accordance with one embodiment. Initially, the read order may be set to read row-wise as indicated in block 102. In block 104, the sequence waits for a valid word in the buffer. Then, in block 106, a valid word in the buffer is read. A check at diamond 108 determines whether the last word of a block has been read. If so, a check at diamond 110 determines whether the last block has been read. If not, the read order is toggled from column to row or vice versa (block 112). If the block is the last block to be read, then the flow ends.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
addressing a block of video information to be compressed in a first addressing sequence;
modifying the first addressing sequence after a block has been accessed; and
accessing the next block in a second addressing sequence different than said first addressing sequence.

2. The method of claim 1 comprising:
writing a first block using a first addressing sequence; and
writing a second block using a second addressing sequence different from said first addressing sequence.

3. The method of claim 1 comprising:
reading a first block using a first addressing sequence; and
reading a second block using a second addressing sequence different from said first addressing sequence.

4. The method of claim 1 including implementing a Microsoft Windows Media® 9 transform.

5. The method of claim 2 including determining when a sub-block has been read of sufficient size to accommodate the next block to be written.

6. The method of claim 1 including writing and reading from a transpose buffer.

7. The method of claim 6 including writing to a transpose random access memory.

8. The method of claim 7 including receiving an 8×8 block followed by a smaller block in a transpose buffer having a capacity of 64 words.

9. A video processing circuit comprising:
a transpose buffer; and
a transform engine coupled to said transpose buffer, said transform engine to write blocks of video data to said transpose buffer and to read blocks of data from said transpose buffer, said transform engine to change the addressing sequence.

10. The circuit of claim 9 including a Windows Media® 9 transform engine.

11. The circuit of claim 10, said engine to determine when 16 words have been read from said buffer.

12. The circuit of claim 11, said engine to store a 4×4 block of data in the space available in said buffer after reading 16 words.

13. The circuit of claim 12, said engine to determine when 32 words have been read from said buffer.

14. The circuit of claim 13, said engine to store an 8×4 or 4×8 block of data in the space available in said buffer after reading 32 words.

15. The circuit of claim 9 including a transform engine to change the addressing sequence for successive buffer writes.

16. The circuit of claim 9 including a transform engine to change the addressing sequence for successive buffer reads.

17. A system comprising:
a processor;
a dynamic random access memory coupled to said processor; and
a video processing circuit including a transpose buffer and a transform engine coupled to said transpose buffer, said transform engine to write blocks of video data to said transpose buffer and to read blocks of data from said transpose buffer, said transform engine to modify the addressing sequence in at least two successive blocks.

18. The system of claim 17, said engine to convert a 4×4 block of video data to two eight word rows.

19. The system of claim 18, said buffer having a capacity of 64 words, said engine to convert a 4×4 block of data to be stored in two eight word rows in said buffer, said engine to determine when 16 words have been read from said buffer and to store a 4×4 block of data in the space available in said buffer after reading 16 words.

20. The system of claim 17, said engine to change the addressing sequence for successive buffer read operations.

21. The system of claim 20, said engine to determine when 32 words have been read from said buffer.

22. The system of claim 17, said engine to change the addressing sequence for successive buffer write operations.

23. A machine readable medium storing instructions that, if executed, enable a processor-based system to:
compress video data using a transpose buffer; and
modify the addressing sequence for said transpose buffer for successive blocks of video data.

24. The medium of claim 23 further storing instructions that, if executed, enable a processor-based system to write a block of video data to a transpose buffer in a column-wise fashion.

25. The medium of claim 24 further storing instructions that, if executed, enable said processor-based system to receive a 4×4 block of data and write said 4×4 block of data into two available eight word rows.
